(19) United States
(12) Patent Application Publication
(10) Pub. No.: US 2016/0167186 A1
(43) Pub. Date: Jun. 16, 2016

(54) POWER TOOLS AND METHODS FOR CONTROLLING THE SAME

(71) Applicant: ELWHA LLC, Bellevue, WA (US)

(72) Inventors: Alistair K. Chan, Bainbridge Island, WA (US); Roderick A. Hyde, Redmond, WA (US); Jordin T. Kare, Seattle, WA (US)

(73) Assignee: ELWHA LLC, Bellevue, WA (US)

(21) Appl. No.: 14/569,271

(22) Filed: Dec. 12, 2014

(51) Int. Cl. B23Q 15/20; G05B 19/418; B25F 5/00

(52) U.S. Cl. CPC B23Q 15/20; B25F 5/00; G05B 19/4185; G05B 2219/33274

(57) ABSTRACT

A power tool includes a body, a motor, a sensor and a processor. The body includes an accessory coupler. The motor is coupled to the body and is configured to drive the accessory coupler. The sensor is coupled to the body and is configured to acquire data regarding a material property of a work piece. The processor is configured to control an operating parameter of the power tool based on the acquired data.

### BACKGROUND

Conventional power tools such as electric drills, sanders, and saws often have preconfigured settings that a user can select depending on an application of the tool. Some power tools are configured to receive information from an electronic database or receive information as a user input to control the tool. The received information can be used to control an operating parameter of the tool such as a motor speed, a force (e.g., a torque), or other similar operating parameter(s).

### SUMMARY

One embodiment relates to a power tool. The power tool includes a body, a motor, a sensor and a processor. The body includes an accessory coupler. The motor is coupled to the body and is configured to drive the accessory coupler. The sensor is coupled to the body and is configured to acquire data regarding a material property of a work piece. The processor is configured to control an operating parameter of the power tool based on the acquired data.

Another embodiment relates to a control system for a power tool. The control system includes a sensor and a processor. The sensor is configured to acquire data regarding a material property of a work piece. The processor is configured to control an operating parameter of the power tool based on the acquired data.

Yet another embodiment relates to a method for controlling a power tool. The method includes acquiring data from a work piece regarding a material property of the work piece using a sensor; transmitting the acquired data to a processor operatively coupled to the power tool; and controlling an operating parameter of the power tool based on the acquired data.

Yet another embodiment relates to a method for controlling a power tool. The method includes acquiring data from a work piece regarding a material property of the work piece using a sensor; receiving data regarding a material property of the work piece from a second power tool; and controlling an operating parameter of the power tool based on at least one of the data acquired by the sensor or the data received from the second power tool.

Yet another embodiment relates to a power tool system. The power tool system includes a first power tool and a second power tool. The second power tool is in electronic communication with the first power tool. The first power tool includes a processor and a communications interface operatively connected to the processor. The communications interface is configured to receive data regarding a material property of a work piece from the second power tool. The processor is configured to control an operating parameter of the first power tool based on the data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view of a power tool in the form of a drill shown in contact with a work piece, according to one embodiment.

FIG. 2A is a side view of a power tool in the form of a sander shown in contact with a work piece, according to one embodiment.

FIG. 2B is a side view of a power tool in the form of a table saw shown in contact with a work piece, according to one embodiment.

FIG. 3 is a schematic diagram of a control system for a power tool, according to one embodiment.

FIGS. 4-9 are block diagrams of various methods for controlling a power tool, according to various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring generally to the Figures, disclosed herein are power tools and methods for controlling power tools using one or more sensors to detect a work piece associated with the tool. The sensors are configured to acquire data from the work piece and to control an operating parameter of the power tool based on the work piece data. In one embodiment, the sensors are configured to detect a characteristic of the work piece, such as a material property (e.g., material type, material thickness, elasticity, etc.), a size, or a shape of the work piece. The sensed information/data is transmitted to a processor of the power tool to control an operating parameter of the tool. Operating parameters of the power tool can include a motor speed (e.g., RPM, material feed rate, etc.), a force (e.g., a torque, a feed force, etc.), a flow of cutting fluid for the tool, or other similar operating parameter of the power tool. In this manner, the power tool can be automatically configured based on the work piece associated with the tool.

In another embodiment, the power tool is configured to transmit information/data to and/or receive information from a second power tool to control an operating parameter of the power tool. In one embodiment, the information received from the second power tool is information/data relating to a work piece detected by one or more sensors of the power tool. Similarly, the information transmitted to the second power tool is information relating to a work piece detected by sensors of the power tool. In this manner, information relating to a given work piece can be directly exchanged between a plurality of power tools to control an operating parameter of one or more of the tools.

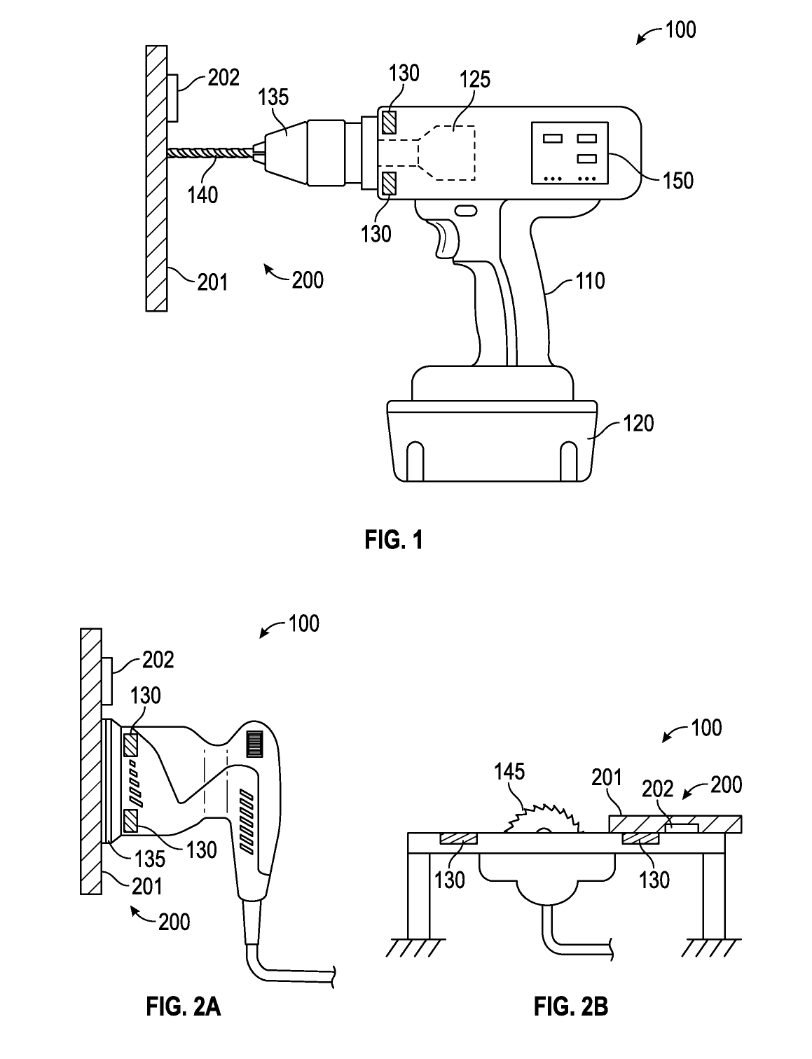

Referring now to FIG. 1, power tool 100 is shown according to one embodiment. As shown in FIG. 1, power tool 100 is a handheld drill. However, it is appreciated that power tool 100 can be another type of power tool, such as an electric sander (shown in FIG. 2A), a saw, or a grinder. Furthermore, power tool 100 can be portable (e.g., handheld, etc.) or stationary, such as a stationary drill press, a table saw (shown in FIG. 2B), a milling machine, a planer, a lathe, a grinder, or other similar type of stationary/fixed position tool. According to the embodiment shown in FIG. 1, power tool 100 includes body 110 having power source 120 coupled thereto. In one embodiment, power source 120 is a battery pack. Power tool 100 also includes motor 125 coupled to body 110. Motor 125 is configured to convert power received from power source 120 into torque to operate/drive a drill bit, such as drill bit 140 shown in FIG. 1. In various embodiments, motor 125 can be an electric motor, a pneumatic drive, a hydraulic drive, or a similar driver, and can be configured to be a rotary or a linear drive (e.g., a pneumatic cylinder, a solenoid, etc.).

In the embodiment shown, drill bit 140 is removably coupled to power tool 100 via accessory coupler 135 extending from body 110. Accessory coupler 135 is coupled to motor 125 such that motor 125 can drive (e.g., rotate, etc.) accessory coupler 135, thereby driving drill bit 140. As shown in FIG. 1, accessory coupler 135 is in the form of a chuck for receiving a drill bit. In other embodiments, accessory coupler 135 is in the form of a mounting device configured to receive a sheet of sandpaper or a cutting blade, as shown in FIGS. 2A and 2B, respectively. By way of the example shown in FIG. 1, drill bit 140 is in contact with surface 201 of work piece 200. Work piece 200 may be a sheet of plywood, dry wall, sheet metal, or any other type of work piece that power tool 100 can be used in conjunction with.

Power tool 100 further includes one or more sensors 130 coupled to a portion of body 110. According to another embodiment, sensors 130 are coupled to a drill bit, such as drill bit 140, or another portion of power tool 100. In another embodiment, sensors 130 are coupled (e.g., housed, contained, etc.) within a separate housing (e.g., a sensor head, a member, etc.) that is coupled to power tool 100. According to one embodiment shown in FIG. 1, two sensors 130 are operatively coupled to a processor (such as central processing unit 310 shown in FIG. 2). In one embodiment, sensors 130 are configured to acquire information about a work piece, such as work piece 200, and to transmit the acquired information relating to the work piece to the processor to control an operating parameter of power tool 100. Sensors 130 are configured to acquire information about the work piece by various sensing techniques, such as remote sensing (i.e., non-contact sensing) and/or direct contact sensing (i.e., contact sensing). For example, sensors 130 are configured to acquire data from a work piece by at least one of imaging, spectral sensing, microwave sensing, thermal sensing, x-ray fluorescence, ultrasound, or other similar types of non-contact sensing technologies. In other embodiments, sensors 130 are configured to acquire data by contact sensing, including detecting/sensing a material hardness, a material strength, a material elasticity, an electromagnetic property, a thickness or other dimension of the material, or any other suitable material property detectable by contact sensing. Direct contact sensing can also include using ultrasound technology, such as transducer type sensing.

According to one embodiment, sensors 130 are configured to read encoded data/properties of a work piece, which can be in the form of an identification or information code 202 associated with work piece 200, to identify/detect information about the work piece. As shown in FIG. 1, identification/information code 202 is disposed on surface 201. In various embodiments, identification/information code 202 can be a barcode, an RFID tag, a written mark, a printed mark, a number or series of numbers, or any other form of identification/information storage that can be detected by sensors 130. In one embodiment, identification/information code 202 directly contains information/data associated with work piece 200, such as a material type, a material hardness, a material thickness, or another similar type of material/work piece property. Power tool 100 can be directly controlled based on the information contained within identification/information code 202. In another embodiment, identification/information code 202 contains identification information about work piece 200 that is associated with material properties or material information stored within a look-up table in power tool 100. For example, power tool 100 can include a memory, (such as memory 320 shown in FIG. 2), including a lookup table having information associated with identification/information code 202. In one embodiment, the information/data contained in the lookup table is material information (e.g., material type, size, properties, etc.) associated with work piece 200. Power tool 100 can be configured to retrieve information from the lookup table based on identification/information code 202 of work piece 200. The retrieved information can be used to control an operating parameter of power tool 100.

According to one embodiment, sensors 130 are configured to detect a characteristic of work piece 200. Characteristics of work piece 200 can include a material property, such as a hardness, a strength, an elasticity, an electromagnetic property, or other type of material property. According to another embodiment, sensors 130 are configured to detect a characteristic associated with an interaction between power tool 100 and work piece 200. By way of the example shown in FIG. 1, when power tool 100 is operating such that drill bit 140 is engaged with (e.g., in contact with, interfacing with, etc.) work piece 200, sensors 130 can detect/sense a characteristic of the interaction between drill bit 140 and work piece 200, such as a noise, a force, a temperature of work piece 200, a size of work piece 200, an appearance of work piece 200, etc. In other embodiments, sensors 130 can detect a cutting torque, a cutting tip temperature of drill bit 140, an impedance property, or a magnetic property. The sensed characteristic of the interaction can be used to infer a material property of the work piece and thereby control various operating parameters of power tool 100, such as a motor speed, a motor force, a feed rate, a feed force, or other similar operating parameters. For example, if sensors 130 determine that the cutting tip temperature of drill bit 140 reaches a predetermined temperature, power tool 100 can infer that the material of work piece 200 has a certain hardness or thickness. Power tool 100 can then adjust an operating parameter, such as motor speed and/or torque, such that power tool 100 achieves optimum performance based on the characteristics of work piece 200.

In another embodiment shown in FIG. 2A, power tool 100 is an electric hand-held abrasive tool shown as a sander having sensors 130 coupled thereto. In other embodiments, power tool 100 is another type of abrasive tool, such as a grinder, a stationary belt sander, or other similar abrasive tool. Sensors 130 are identical to sensors 130 of FIG. 1, and are configured to track a position of the sander on work piece 200 shown in FIG. 2A. In one embodiment, sensors 130 are configured to detect an applied force of the sander on work piece 200. The detected position and force information can be used to indicate to a user which areas/portions of work piece 200 have been over/under sanded.

In another embodiment, the sander is configured to automatically change a surface property (i.e., an abrasive property such as a sand paper grit size, etc.) by changing sandpaper sheets having different grit sizes based on a detected condition of work piece 200. In one embodiment, sensors 130 on the sander are configured to obtain data regarding a roughness or scratch size of surface 201 after sanding an area of surface 201. The sander is configured to process the data to determine an acceptable grit size/sandpaper for the sander based on the detected surface property. In this manner, the sander can progressively adjust a grit size based on data obtained from work piece 200 to achieve a desired surface finish of surface 201. In one embodiment, the data is the largest average scratch size (e.g., scratch depth, etc.) on a surface of a work piece. In another embodiment, the data is the largest scratch size identified on a surface of a work piece. In other embodiments, the data is another surface property associated with the work piece, such as a surface texture, a roughness, or other similar surface property.

In another embodiment shown in FIG. 2B, power tool 100 is a stationary table saw. In other embodiments, power tool 100 is a similar type of cutting device (e.g., chain saw, reciprocating saw, etc.). As shown in FIG. 2B, the saw includes blade 145 coupled to the saw. The saw also includes sensors 130 coupled to a portion of the saw. The saw is shown engaged with work piece 200. In one embodiment, sensors 130 are configured to obtain information relating to the work piece 200, such as a size of chipping of edges (i.e., cut edges, etc.) of surface 201 when blade 145 is engaged with work piece 200. The saw is configured to process the data to determine a preferred characteristic of the saw, such as a blade size, tooth type, or blade thickness. The saw may be configured to determine an optimum cutting condition (e.g., blade height, blade speed, cutting force, cutting speed) based on the information obtained regarding the work piece 200. For example, if sensors 130 determine that an edge chip on surface 201 of work piece 200 is severe based on a detected size of the edge chip, power tool 100 can reduce the severity of the edge chip by changing blade 145 of the saw to a preferred blade.

In one embodiment, power tool 100 can determine the accessory type or size (e.g., a drill bit type or size, a saw blade tooth size, a sandpaper grit, etc.) by information detected from the accessory. For example, an accessory, such as a cutting blade, can include information about the accessory in the form of a code or a marking on the blade. The information can be, for example, information regarding a size of the blade, the number of cutting teeth, the material of the blade, or other similar information relating to a property of the blade. The information can be detected by an accessory sensor similar to sensor 130, which can be located, for example, near accessory coupler 135, according to one embodiment. The accessory sensor can detect the information on the blade and the detected information can be used by power tool 100 to determine whether or not the accessory is suitable for a particular job based on information obtained from a work piece (e.g., whether a particular cutting blade is suitable to cut through a work piece such as a steel plate).

In another embodiment, power tool 100 can determine an accessory using direct sensing, such as by using the accessory sensor disposed near accessory coupler 135. The accessory sensor can detect a property/condition of accessory coupler 135, such as by determining the size of a chuck opening to accept a drill bit. Similarly, the accessory sensor can detect a property/condition of the accessory itself, such as a size of the spacing between cutting teeth on a cutting blade, for example, by imaging the blade (i.e., sensors 130 can be imaging type sensors). The detected information can be used to determine whether the current/selected accessory is suitable for a particular job based on previous information obtained regarding a work piece.

According to another embodiment, power tool 100 can determine an accessory by a user input. For example, power tool 100 can include a user interface configured to allow a user to input information relating to a chosen accessory. Power tool 100 can provide one or more inquiries/requests to the user via the user interface such that a user can provide information regarding the accessory, such as, for example, a type of accessory, a part number for the accessory, or other similar property of the accessory. The user can respond to the request(s) and the response information can be used to determine whether the selected accessory is suitable for a particular job.

According to one embodiment, sensors 130 used on the portable power tools of FIGS. 1-2A include at least one sensor configured to detect a condition of a work piece at a location in front of the power tool. For example, sensors 130 on power tool 100 can be used to prevent power tool 100 from being damaged and/or to protect a user from being hurt. The condition detected by sensor 130 can include an interface between different materials, a cavity, an obstruction, an end of a work piece, or any other feature of the work piece that could damage power tool 100 or potentially hurt a user of power tool 100.

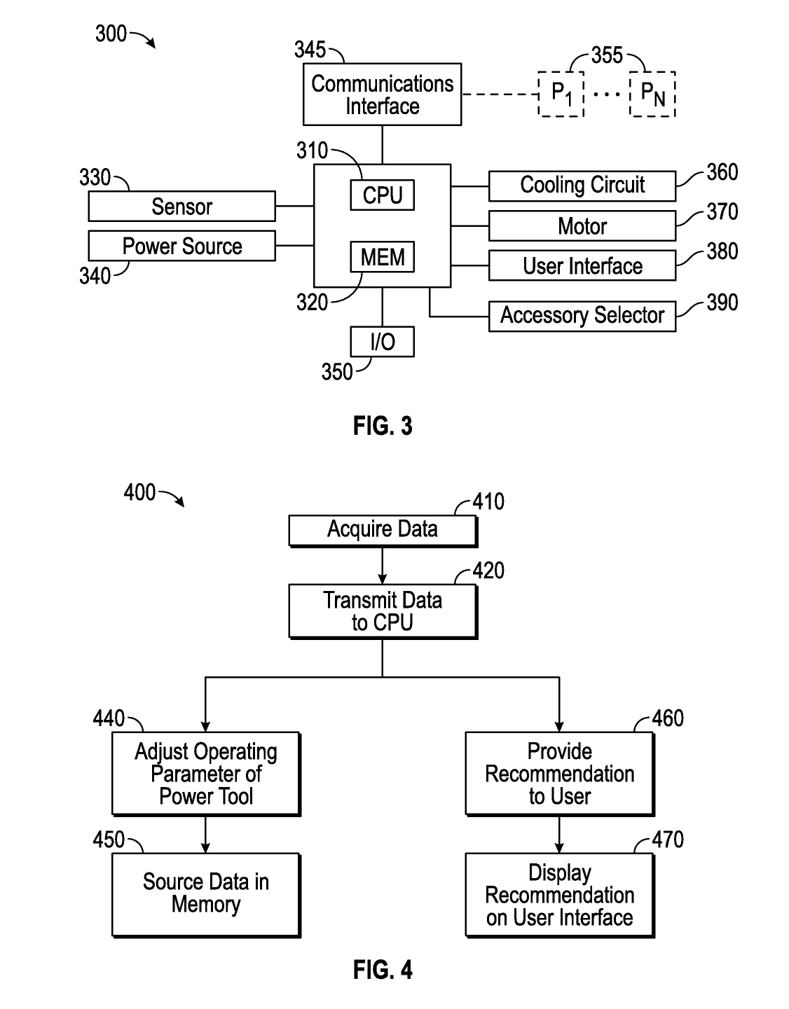

Referring now to FIG. 3, a schematic diagram of control system 300 for power tool 100 is shown, according to one embodiment. Control system 300 includes central processing unit 310 (e.g., processor, etc.) operatively coupled to one or more sensors 330 and to power source 340. Central processing unit 310 is operatively coupled to power tool 100 to control various functions of power tool 100, such as motor speed/torque, a cooling circuit (e.g., a cutting fluid), a user interface/display, an accessory (e.g., an automatic drill bit changer, etc.), lubrication, etc. By way of the example shown in FIG. 3, central processing unit 310 is operatively coupled to cooling circuit 360, motor 370, user interface 380, and accessory 390. However, it is appreciated that central processing unit 310 can be configured to control other functions of power tool 100, such as a feed rate or feed force, a normal force (e.g., for a sander, such as the sander shown in FIG. 2A), a cutting blade height (e.g., for a saw, such as the saw shown in FIG. 2B), a blade tension (e.g., for a band saw), or other functions associated with power tool 100.

According to one embodiment, central processing unit 310 is configured to control an operating parameter of power tool 100 based on information about a work piece. Operating parameters of power tool 100 can include a speed of motor 370, a torque of motor 370, a feed rate, a feed force, and a flow of cutting fluid/lubrication for power tool 100. By way of the example shown in FIGS. 1 and 2, sensors 130 can acquire information about work piece 200, such as a material property of work piece 200, and transmit the data to central processing unit 310 (shown in FIG. 3). Central processing unit 310 can process the transmitted information and adjust (e.g., modify, control, etc.) an operating parameter of power tool 100 such that power tool 100 achieves optimum performance. By way of the example shown in FIG. 1, if sensors 130 acquire material data about work piece 200 and determine that work piece 200 is a hard material, such as steel, central processing unit 310 can control motor 370 by decreasing a speed or increasing a torque of motor 370, or selecting a different gear ratio of motor 370 such that power tool 100 can effectively drill through work piece 200. In this manner, power tool 100 can achieve optimum performance based on a detected characteristic of work piece 200.

According to one embodiment, central processing unit 310 is configured to send a recommendation to a user of power tool 100 based on the data associated with the work piece. For example, central processing unit 310 can recommend a drill bit size, a drill bit type, a speed of motor 370, a torque of motor 370, a cutting fluid flow rate for cooling circuit 360, or other similar types of operating parameters. In one embodiment, the recommendation can be displayed on a user interface, such as user interface 150 shown in FIG. 1. As shown in FIG. 1, user interface 150 is disposed on a side surface of power tool 100. In other embodiments, user interface 150 may be located on a different portion of power tool 100. User interface 150 includes a display screen configured to display information to a user, such as a recommendation received from central processing unit 310. The display screen can be any type of electronic display and/or touch screen, such as a liquid crystal display (LCD), an LED display, or other similar type of display. User interface 150 is also configured to receive an input from a user to control an operating parameter of power tool 100.

According to one embodiment, central processing unit 310 is configured to provide a signal to a user to modify an operating parameter of power tool 100 via input/output 350. Similarly, central processing unit 310 is configured to provide a warning signal to a user to indicate that power tool 100 should not be used based on a detected characteristic of a work piece. In both embodiments, the signal can be an audible signal (e.g., a horn, a beep, a voice message, etc.), a visual signal (e.g., a light bulb indicator, an LED, etc.), a tactile signal (e.g., vibration, etc.), or a combination of signals. For example, if central processing unit 310 determines that drill bit 140 should not be used on work piece 200 based on a detected characteristic of work piece 200, central processing unit 310 can transmit a signal via input/output 350 to alert a user that drill bit 140 should not be used and/or should be changed.

According to one embodiment, power tool 100 includes accessory selector 390. In one embodiment, accessory selector 390 is an automatic drill bit changer configured to automatically change a drill bit based on data relating to a work piece. The automatic drill bit changer can be an integrated sub-system of power tool 100. By way of the example shown in FIG. 1, if power tool 100 is being used to drill a hole in work piece 200 using drill bit 140 and sensors 130 determine that drill bit 140 is insufficient (e.g., drill bit is too small, work piece is made of insufficiently hard material, etc.) based on a detected characteristic of work piece 200, central processing unit 310 can instruct power tool 100 to stop operating and to change drill bit 140 via accessory selector 390. In this manner, a different drill bit can be automatically selected for a given application of power tool 100 based on a detected characteristic of work piece 200. In one embodiment, sensors 130 can determine the available accessory options for power tool 100 by sensing the number of available accessories contained within power tool 100 (e.g., within accessory selector 390), such as the number of available drill bits in an automatic drill bit changer of power tool 100. According to other embodiments, accessory selector 390 can be a cutting blade selector, a sand paper selector, or other similar type of automatic selector/controller for power tool 100.

According to one embodiment, central processing unit 310 is configured to request a user to perform an action to identify a work piece and/or to obtain more information about a work piece to control an operating parameter of power tool 100. By way of the example shown in FIG. 1, before power tool 100 is applied to work piece 200, central processing unit 310 can request a user to drill a test hole in work piece 200 to allow sensors 130 to detect a condition/characteristic of work piece 200. In another embodiment, central processing unit 310 is configured to request a user to perform a different action, such as selecting a particular sensor 130 to acquire data from work piece 200. In this manner, power tool 100 can make a more accurate determination of a characteristic of work piece 200 to control an operating parameter of power tool 100.

In one embodiment, central processing unit 310 is configured to request additional information from a user to select an operating parameter of power tool 100. In various embodiments, the additional information includes a desired hole size to drill and/or a finish quality of the work piece. By way of the example shown in FIG. 1, before power tool 100 is used to drill a hole in work piece 200, central processing unit 310 can request a user to input a desired hole size via user interface 380 (shown as user interface 150 in FIG. 1). The user can input a desired hole size and central processing unit 310 can select a proper drill bit corresponding to the desired hole size using accessory selector 390, where accessory selector 390 is an automatic drill bit changer.

According to one embodiment, memory 320 of power tool 100 is configured to store an operating parameter associated with a work piece for future reference/use by power tool 100. For example, when sensors 130 acquire data relating to a work piece and central processing unit 310 controls an operating parameter of power tool 100 based on the acquired data, central processing unit 310 can prompt a user to store information in memory 320 relating to the work piece for future use. The request/prompt to store information in memory 320 can be displayed on user interface 150 (shown as reference numeral 380 in FIG. 3) such that a user can select whether to store the information or not. The user can recall the stored information at a later time when using power tool 100, or power tool 100 can automatically retrieve the stored information if it senses (via sensors 130) a similar work piece. In another embodiment, memory 320 is configured to store and recall user behavior and/or preferences. For example, power tool 100 can store a user preference such as a higher speed for cutting and a lower quality of the cut finish. Likewise, power tool 100 can store a different user preference, such as a lower speed of cutting to achieve a desired useful life (i.e., a longer useful life) of the cutting blade or drill bit. Memory 320 can store these user preferences and recall them automatically or by user selection.

According to one embodiment, power tool 100 includes wireless communications interface 345 is configured to transmit information/data relating to a given work piece to at least one other power tool 355 (i.e., a second power tool) (designated by reference numeral P₁, . . . Pₙ). In another embodiment, communications interface 345 is configured to receive information relating to a given work piece from at least one other power tool 355 (i.e., a second power tool). The information transmitted directly between power tools can be used to control an operating parameter of a respective power tool. In one embodiment, the information transmitted to power tool 355 is the information (i.e., data, etc.) acquired by sensors 130 of power tool 100. In another embodiment, the information transmitted to and/or received from power tool 355 is information that is input by a user (e.g., via user interface 150 of FIG. 1). The information transmitted to and/or received from power tool 355 can be used to preconfigure a fixture, such as a table height for the fixture. In another embodiment, the information transmitted to and/or received from power tool 355 is used to control accessory selector 390 to, for example, select an appropriate drill bit for an application of power tool 100. In various embodiments, communications interface 345 is configured to communicate wirelessly with power tool 355. In one embodiment, power tool 100 is configured to communicate with power tool 355 using a wireless communication protocol, such as Bluetooth or any other suitable wireless communication.

In the various embodiments described herein, central processing unit 310 may be implemented as a general-purpose processor, an application specific integrated circuit (ASIC), one or more field programmable gate arrays (FPGAs), a digital-signal-processor (DSP), a group of processing components, or other suitable electronic processing components. Memory 320 is one or more devices (e.g., RAM, ROM, Flash Memory, hard disk storage, etc.) for storing data and/or computer code for facilitating the various processes described herein. In other embodiments, memory 320 may be a portable storage device such as an SD card, a micro SD card, or other similar type of portable storage device that can be removably coupled to power tool 100 such that a user can remove the device and download information to or from the device or use the portable memory in another power tool or a plurality of different power tools. In one embodiment, memory 320 may be a remote unit coupled to power tool 100. Memory 320 may be or include non-transient volatile memory or non-volatile memory. Memory 320 may include database components, object code components, script components, or any other type of information structure for supporting the various activities and information structures described herein. Memory 320 may be communicably connected to central processing unit 310 and provide computer code or instructions to central processing unit 310 for executing the processes described herein.

Referring now to FIGS. 4-9, various methods for controlling a power tool, such as power tool 100 shown in FIGS. 1 and 2, are shown according to various embodiments. In one embodiment shown in FIG. 4, method 400 includes acquiring data from a work piece (410), such as work piece 200 shown in FIGS. 1 and 2, using sensors 130. Method 400 further includes transmitting information associated with the work piece to a processor (420), such as central processing unit 310 shown in FIG. 3.

According to one embodiment, acquiring data related to the work piece (410) includes detecting a characteristic associated with an interaction between power tool 100 and a work piece. Characteristics associated with the interaction between power tool 100 and a work piece can include at least one of a noise, a force, a temperature of the work piece, a size of the work piece, a size of an edge chip, or an appearance of the work piece. In another embodiment, acquiring data from the work piece (410) includes detecting a condition of the work piece at a location in front of power tool 100 using at least one ultrasonic sensor coupled to power tool 100. The condition of the work piece can include at least one of an interface between different materials, a cavity, an obstruction, and an end of the work piece.

In one embodiment, method 400 includes identifying a work piece by looking up an identification code, such as identification/information 202 in FIGS. 1 and 2, corresponding to work piece 200 from a look-up table stored in memory 320 of power tool 100. In another embodiment, identification/information code 202 contains information regarding work piece 200 that can be used to directly control power tool 100. In various embodiments, identification/information code 202 can be a barcode, an RFID tag, a marking, or other type of identification code that can be sensed/detected by sensors 130. The look-up table can include information associated with a given work piece. In one embodiment, the look-up table includes material information, such as material type, material properties, electromagnetic properties, etc. The information contained within the look-up table can be used to control an operation of power tool 100. In another embodiment, sensors 130 can detect a condition/property of the work piece (410). A signal corresponding to the detected condition/property can be transmitted to central processing unit 310 to control an operating parameter of power tool 100 (440) and/or to provide a recommendation to a user (460).

In one embodiment shown in FIG. 4, method 400 includes controlling/adjusting an operating parameter of power tool 100 based on the acquired work piece data (440). As discussed above, operating parameters of power tool 100 can include at least one of a speed, a feed rate, a force (e.g., a torque, a feed force, etc.), and an amount/flow rate of cutting fluid for power tool 100. Method 400 further includes storing the data associated with the work piece in memory 320 for future reference/use (450) by power tool 100.

According to another embodiment, method 400 includes providing a recommendation to a user of power tool 100 based on the work piece data (460). Method 400 may also include displaying the recommendation on a user interface (470), such as user interface 150 of FIG. 1. The recommendation provided to the user can include at least one of a recommended drill bit size, drill bit type, a grit size/type, a cutting blade size/type, a motor speed, a feed rate, a force (e.g., a torque, a feed force, etc.), a coolant/cutting fluid type, and a coolant/cutting fluid flow rate for power tool 100.

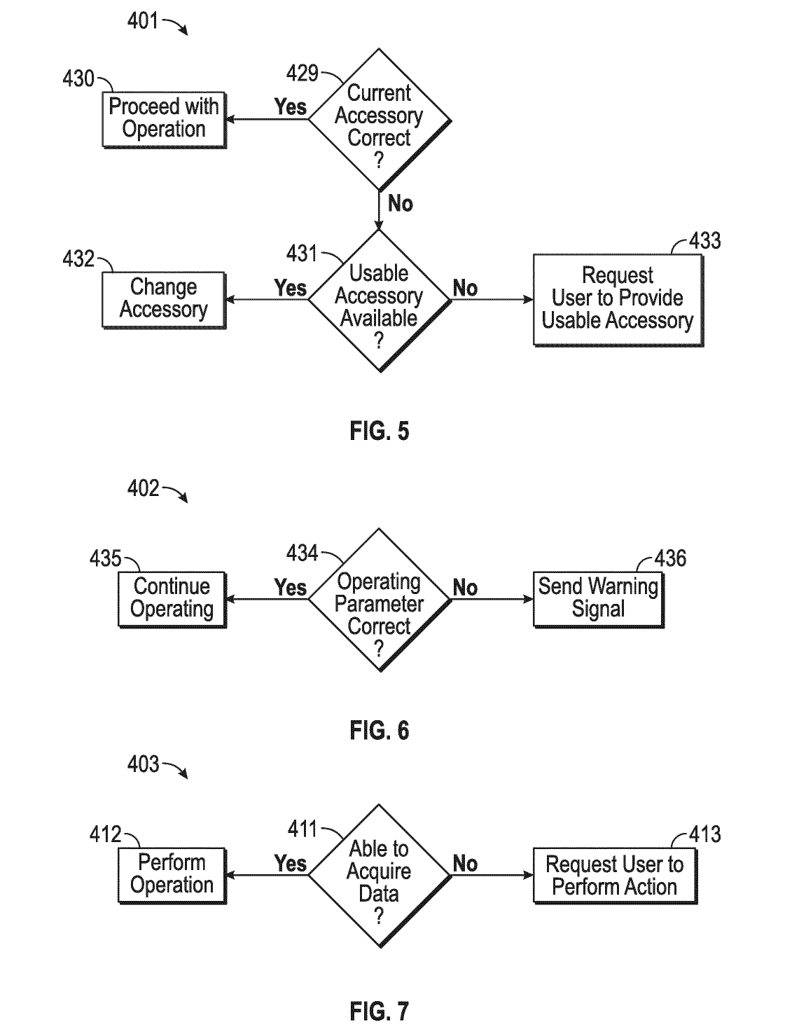

According to another embodiment shown in FIG. 5, method 401 includes determining whether a current tool accessory is correct for a particular job (429). If the processor determines that the current tool accessory is correct, power tool 100 will be instruction to proceed with operation (430). If the processor determines that the current tool accessory is not correct/suitable for a particular job, power tool 100 will determine whether a usable tool accessory (e.g., a drill bit, a cutting blade, a piece of sand paper, a grit size, etc.) is available (431). This can be performed by using one or more accessory sensors located near, for example, accessory coupler 135 of power tool 100. In another embodiment, determining whether a tool accessory is available includes receiving a user input to determine whether a usable tool accessory is available. If a usable tool accessory is not available for use by power tool 100, method 401 includes performing requesting a user to provide a usable accessory for the tool (433). In one embodiment, step 433 can be displayed on a user interface as an error code or a similar indication to a user. If a usable tool accessory is available for use by power tool 100, method 401 includes changing the current tool accessory to select the usable tool accessory, such as by using accessory selector 390.

According to another embodiment shown in FIG. 6, method 402 includes determining whether an operating parameter of power tool 100 is correct (i.e., sufficient, acceptable, etc.) for a given work piece (434). If the operating parameter of power tool 100 (e.g., motor speed, force, etc.) is correct, method 402 includes continuing to operate power tool 100 with the current operating parameters/settings (435). If the operating parameter of power tool 100 is incorrect (e.g., not suitable, insufficient, inappropriate, etc.), method 402 includes sending a signal to a user to modify/adjust an operating parameter of power tool 100. In one embodiment, the signal can be a warning to a user to stop operating power tool 100. By way of example, the signal can be an audible signal, a visual signal, a tactile signal, or a combination of signals to alert the user to change/modify an operating parameter and/or to stop operating power tool 100.

According to another embodiment shown in FIG. 7, method 403 includes determining whether data from a work piece was acquired by sensors (411), such as sensors 130 of FIGS. 1 and 2. If the sensors are able to acquire data from the work piece, method 403 includes performing an operation (412), such as adjusting an operating parameter of power tool 100 and/or sending a recommendation to a user of power tool 100 based on the acquired data. If the sensors are unable to acquire data from the work piece, method 403 includes requesting a user to perform an action to identify/detect the work piece (413). By way of the example in FIG. 1, if sensors 130 are unable to acquire data from work piece 200, central processing unit 310 can request a user to drill a test hole in work piece 200 to allow sensors 130 to detect a condition/characteristic of work piece 200. In another embodiment, central processing unit 310 can request that a user perform a different action, such as selecting a particular sensor 130 located on power tool 100 to acquire data from work piece 200.

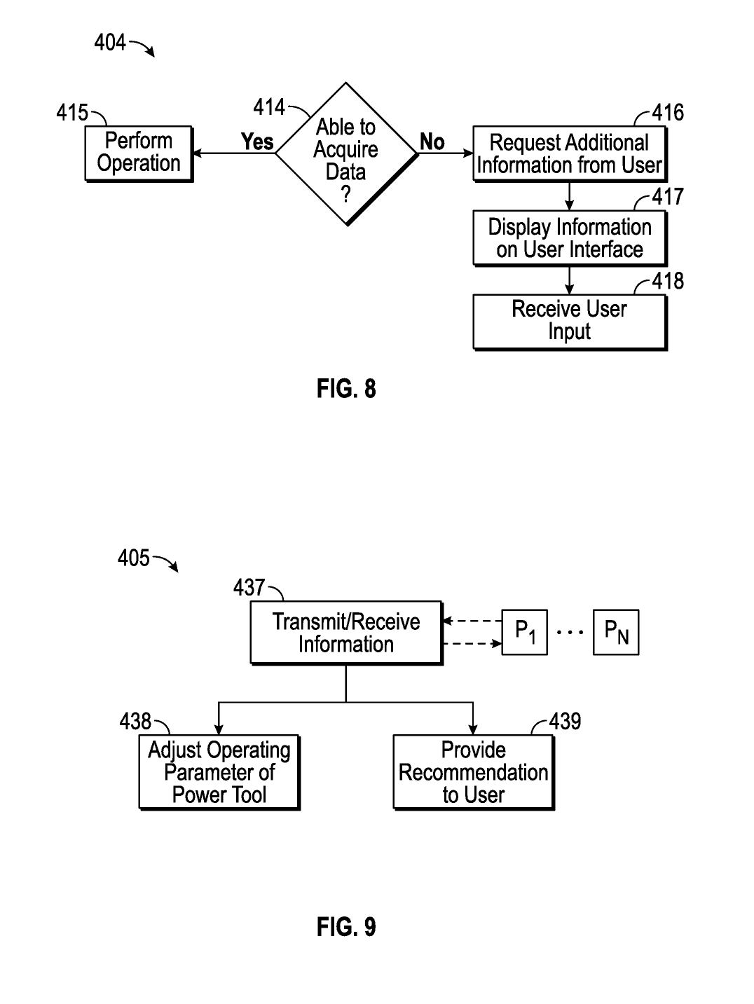

In one embodiment shown in FIG. 8, method 404 includes requesting additional information from a user to select an operating parameter of power tool 100 (416). In the embodiment shown in FIG. 8, the request for additional information is a result of sensors 130 not being able to acquire data from a work piece. If sensors 130 are able to acquire data from the work piece, method 404 includes performing an operation (415), such as adjusting an operating parameter of power tool 100 and/or sending a recommendation to a user of power tool 100 based on the work piece data. In other embodiments, the request for additional information can occur regardless of whether the data is acquired from the work piece. The additional information can include at least one of a desired hole size to drill and a finish quality of the work piece associated with power tool 100. In one embodiment, method 404 includes displaying information associated with the work piece for a user to view (417). According to another embodiment, method 404 includes receiving a user input via a user interface (418), such as user interface 150 of FIG. 1, to control an operation (i.e., an operating parameter, etc.) of power tool 100. In various embodiments, the user input can be a value associated with a motor speed, a torque, a drill bit size, a grit size, a cutting blade size, a desired hole size, or any other input for controlling power tool 100.

According to one embodiment shown in FIG. 9, method 405 includes transmitting information relating to a given work piece to at least one other power tool (P₁, . . . Pₙ) using, for example, a communications interface (e.g., a transmitter/receiver, etc.), such as communications interface 345 of FIG. 3. In one embodiment, method 405 includes receiving information relating to a given work piece from at least one other power tool (437). The information relating to a given work piece is received by a wireless communications interface, such as wireless communications interface 345. In one embodiment, transmitting information to at least one other power tool (P₁, . . . Pₙ) includes using Bluetooth communication protocol. In various embodiments, the information transmitted to at least one other power tool (P₁, . . . Pₙ) includes a characteristic of the work piece. The characteristic of the work piece can include at least one of a material type, a size, a shape or dimension, a hardness, a temperature, or a moisture content of the work piece.

According to another embodiment, method 405 includes receiving information from at least one other power tool (P₁, . . . Pₙ) to control an operation of power tool 100. In one embodiment, the information transmitted to or received from at least one other power tool (P₁, . . . Pₙ) is input by a user. According to another embodiment, the information transmitted to or received from at least one other power tool (P₁, . . . Pₙ) is used to preconfigure a fixture for power tool 100, such as setting a height of a table for power tool 100. In another embodiment, the information transmitted to or received from at least one other power tool (P₁, . . . Pₙ) is used to select a tool accessory (e.g., a drill bit, a cutting blade, a piece of sand paper, etc.) for power tool 100 using an accessory selector, such as accessory selector 390 of FIG. 2.

In one embodiment, the information transmitted to or received from at least one other power tool (P₁, . . . Pₙ) is used to control an operating parameter of power tool 100 (438). In various embodiments operating parameters can include a motor speed, a force (e.g., a torque, etc.), and an amount of lubrication for power tool 100. In another embodiment, the information transmitted to or received from at least one other power tool (P₁, . . . Pₙ) is used to control power tool 100 to compensate for a condition of the work piece associated with power tool 100. In various embodiments, the condition of the work piece can include a shape, a thickness, and a material property of the work piece.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A power tool, comprising:
a body including an accessory coupler;
a motor coupled to the body and configured to drive the accessory coupler;
a sensor coupled to the body and configured to acquire data regarding a material property of a work piece; and
a processor configured to control an operating parameter of the power tool based on the acquired data.

2. The power tool of claim 1, wherein the operating parameter is at least one of a speed of the motor, a force of the motor, a feed rate for the power tool, or a flow of cutting fluid for the power tool.

3. The power tool of claim 1, wherein the processor is configured to provide a recommendation to a user of the power tool based on the work piece data.

4. The power tool of claim 3, wherein the recommendation is at least one of a recommended accessory size or type, a speed of the motor, a feed rate for the power tool, or a flow rate of cutting fluid for the power tool.

5. The power tool of claim 1, wherein the sensor is configured to acquire the data by a non-contact sensing technique.

6. (canceled)

7. The power tool of claim 1, wherein the sensor is configured to acquire the data by a contact sensing technique.

8. (canceled)

9. The power tool of claim 1, wherein the sensor is configured to detect a characteristic associated with an interaction between the power tool and the work piece.

10. The power tool of claim 9, wherein the characteristic includes at least one of a noise, a force, a temperature of the work piece, a size of the work piece, or an appearance of the work piece.

11-41. (canceled)

42. A control system for a power tool, comprising:
a sensor configured to acquire data regarding a material property of a work piece; and
a processor configured to control an operating parameter of the power tool based on the acquired data.

43. The control system of claim 42, wherein the data received by the power tool includes a material characteristic of the work piece.

44. (canceled)

45. The control system of claim 42, further comprising a communications interface configured to receive data regarding a material property of the work piece from a second power tool to control an operating parameter of the power tool.

46. The control system of claim 45, wherein the communications interface is configured to transmit the acquired data from the power tool to a third power tool to control an operating parameter of the third power tool.

47. The control system of claim 45, wherein the information received from the second power tool is input by a user.

48. (canceled)

49. The control system of claim 45, wherein the processor is configured to use the information received from the second power tool to select a tool accessory for the power tool.

50. (canceled)

51. The control system of claim 45, wherein the processor is configured to use the information received from the second power tool to control the power tool to compensate for a condition of the work piece.

52. The control system of claim 51, wherein the condition of the work piece includes at least one of a shape, a thickness, or a material property.

53. The control system of claim 42, wherein the processor is configured to control an operating parameter of the power tool based on the data.

54. (canceled)

55. The control system of claim 42, wherein the processor is configured to provide a recommendation to a user of the power tool based on the data.

56-67. (canceled)

68. The control system of claim 42, further comprising an accessory selector configured to automatically change a tool accessory based on the acquired data.

69. (canceled)

70. The control system of claim 42, wherein the processor is configured to send a signal to a user to modify an operating parameter of the power tool, wherein the signal is at least one of an audible signal, a visual signal, or a tactile signal.

71. The control system of claim 42, wherein the processor is configured to provide a signal to request a user to perform an action to identify the work piece.

72. The control system of claim 42, wherein the processor is configured to provide a signal to request additional information from a user to select an operating parameter or a desired result of the power tool.

73. The control system of claim 72, wherein the additional information includes at least one of a desired hole size, a hole depth, a cut depth, a cut width, a cut length, or a surface finish quality of the work piece.

74. The control system of claim 42, wherein the processor is configured to send a warning signal to a user to indicate that the power tool should not be used based on a detected characteristic of the work piece.

75. The control system of claim 42, wherein the sensor is configured to read encoded data associated with the work piece to obtain data about the work piece.

76. The control system of claim 75, wherein the encoded data is in the form of an identification/information code associated with the work piece, and wherein the identification/information code is at least one of a barcode, a QR code, an RFID tag, a written mark, or a printed mark.

77-177. (canceled)

178. A power tool system, comprising:
a first power tool, the first power tool comprising:
a processor; and
a communications interface operatively connected to the processor;
a second power tool in electronic communication with the first power tool;
wherein the communications interface is configured to receive data regarding a material property of a work piece from the second power tool; and
wherein the processor is configured to control an operating parameter of the first power tool based on the data.

179. The system of claim 178, wherein the data includes a material characteristic of the work piece.

180. (canceled)

181. The system of claim 178, wherein the data is input by a user.

182. (canceled)

183. The system of claim 178, wherein the data is used to select a tool accessory for the first power tool.

184. The system of claim 183, wherein the tool accessory is at least one of a bit, a cutting blade, or an abrasive.

185-186. (canceled)

187. The system of claim 178, wherein the data is used to control an operating parameter of the first power tool.

188-191. (canceled)

192. The system of claim 178, wherein at least one of the first or second power tools is portable.

193. The system of claim 178, wherein at least one of the first or second power tools is stationary.

194. (canceled)

195. The system of claim 178, wherein the communications interface is configured to communicate wirelessly with the second power tool.
